(19) United States
(12) Patent Application Publication
(10) Pub. No.: US 2025/0160568 A1
(43) Pub. Date: May 22, 2025

(54) AIR FRYER

(71) Applicant: NINGBO AGSUN PRODUCTS,INC., CIXI (CN)

(72) Inventors: Hantao Zhao, CIXI (CN); Caihua Sun, CIXI (CN); Xianghua Liu, CIXI (CN); Xuefei Mao, CIXI (CN)

(21) Appl. No.: 19/031,152

(22) Filed: Jan. 17, 2025

(30) Foreign Application Priority Data
Dec. 20, 2024 (CN) 202411894920.2

(51) Int. Cl. A47J 37/06; A47J 36/26; A47J 37/07

(52) U.S. Cl. CPC A47J 37/0623; A47J 36/26; A47J 37/0713; A47J 37/0763

(57) ABSTRACT

The invention discloses an air fryer, including a housing and a fryer body, where a first chamber, a second chamber and a partition plate are provided in the housing, and a third flow guide opening is provided on the partition plate; a cooking cavity is provided in the fryer body, and a heat flow inlet is provided on a side wall of the fryer body; and the housing is provided with a bottom plate and a heating region, and the bottom plate is provided with a second flow guide opening. By adopting the above solution, there is provided an air fryer which provides heat energy by burning the flame, and heats food in a cooking cavity by means of heat flow and heat conduction.

### TECHNICAL FIELD

The invention belongs to the field of outdoor cookers, and specifically relates to an air fryer.

### BACKGROUND

An air fryer is a machine that uses air to “fry” food, primarily using air to replace hot oil in a fryer to cook the food.

The existing air fryer generally includes a machine body and a fryer body, food to be cooked can be placed in the fryer body, and then inserted into the machine body along with the fryer body, and an electric heating wire and a fan are provided in the machine body, so that the electric heating wire is energized to generate heat, and a heat flow is formed under the blowing action of the fan, and the heat flow enters the fryer body to heat the food in the fryer body.

A problem with existing air fryers is that: both the electric heating wire and the fan need to be powered, that is, the existing air fryers are all operated with the electric power, and when used outdoors, there is often no power available, so that the existing air fryers are unable to effectively adapt to outdoor usage scenarios.

### SUMMARY

In view of the deficiencies of the prior art, it is an object of the present invention to provide an air fryer which provides heat energy by burning a flame, and heats food in a cooking cavity by means of heat flow and heat conduction.

In order to achieve the above object, the present invention provides the following technical solutions.

An air fryer, includes: a housing, where a first chamber, a second chamber located on both sides of the first chamber and partition plates separating the first chamber from the second chamber are provided in the housing, a plug-in opening is provided on one side of the first chamber, and a third flow guide opening is provided on the partition plates to communicate the first chamber with the second chamber; and a fryer body, where the fryer body is disassembled and assembled relative to the first chamber by the plug-in opening, a cooking cavity is provided in the fryer body, and a heat flow inlet is provided on a side wall of the fryer body; the housing is provided with a bottom plate located below the first chamber and the second chamber, the housing is provided with a heating region located below the bottom plate, a second flow guide opening is provided on the bottom plate to communicate the second chamber with the heating area, the heating region is configured to provide a space for flame combustion, and a heat flow generated by the flame combustion enters the cooking cavity through the second flow guide opening, the second chamber, the third flow guide opening, the first chamber and the heat flow inlet in sequence.

The present invention is further provided that: first convex portions are provided in the first chamber, and the first convex portions support the fryer body so that a first air region is formed between a bottom portion of the fryer body and the bottom plate; the number of the first convex portions is two, and the two first convex portions are respectively arranged on both sides of the bottom plate to correspond to two partition plates; and an upper surface of the first convex portion is concavely provided with a flow guide groove, and air flow in the first air region flows between the partition plates and the side wall of the fryer body through the flow guide groove and continues to rise through the heat flow inlet to enter the cooking cavity.

The present invention is further provided that: the bottom plate includes a first plate body located below the first chamber; and the first plate body is a closed plate body to separate the heating region from the first chamber, and the first plate body is a heat conducting plate.

The present invention is further provided that: the bottom plate includes a first plate body located below the first chamber; and a first flow guide opening is provided on the first plate body to communicate the heating region with the first air region, and the heat flow generated by the flame combustion in the heating region enters the first air region through the first flow guide opening.

The present invention is further provided that: the bottom portion of the fryer body is provided with an annular first support portion and a sunken portion located on an inner periphery of the first support portion, the first support portion is placed on the two first convex portions to be supported, and the sunken portion is located between the two first convex portions for positioning; and a shelf arranged on the first support portion is provided in the cooking cavity, the shelf and the sunken portion enclose a second air region, and a rising opening is provided on the shelf to allow air in the second air region to flow upward.

The present invention is further provided that: an access opening is provided above the fryer body for the heat flow in the cooking cavity to flow out upward; the housing is provided with a first heat dissipation opening for communicating the first chamber with the outside; a lowest position of the first heat dissipation opening is higher than the access opening; or the lowest position of the first heat dissipation opening is lower than the access opening, a height difference between the lowest position of the first heat dissipation opening and the access opening is h1, a height of the fryer body is h2, and h2≥30*h1; and the housing is provided with a second heat dissipation opening for communicating the second chamber with the outside, the partition plate is provided with a fourth flow guide opening for communicating the first chamber with the second chamber, and a lowest position of the fourth flow guide opening is higher than the access opening and the second heat dissipation opening.

The present invention is further provided that: the plug-in opening is arranged on a front side of the first chamber, and the second chamber is arranged on left and right sides of the first chamber; and the fryer body includes a panel, a vessel and a handle, the vessel is fixedly arranged on a rear side of the panel, the handle is fixedly arranged on a front side of the panel, the vessel is inserted into the first chamber through the plug-in opening, and the plug-in opening is closed by the panel.

The present invention is further provided that: the housing is provided with a heat-collecting hood surrounding an outer periphery of the heating region, and the heat-collecting hood is provided with an air intake opening communicating the heating region with the outside.

The present invention is further provided that: the air fryer further includes a gas burner, and the housing is placed on the gas burner to allow the gas burner to burn and produce a flame in the heating region.

The present invention is further provided that: the gas burner includes a cooktop and a burner provided on the cooktop, the cooktop is provided with a positioning peripheral edge surrounding an outer periphery of the burner such that a combustion region is formed in the positioning peripheral edge, the housing is placed in the combustion region, and an outer peripheral wall of the housing is surrounded and positioned by the positioning peripheral edge.

The present invention is further provided that: second support portions protruding upward are provided on left and right sides of a bottom portion of the combustion region, and a bottom portion of the housing is supported on the second support portions; a flip cover is provided in the combustion region in a flipping manner, and a hinge position of the flip cover is located on a rear side of the combustion region and above the second support portions; the flip cover has an open state and a closed state; when in the open state, the flip cover is inclined backward and upward, and is supported against a rear side of an inner periphery of the positioning peripheral edge; and when in the closed state, left and right sides of the flip cover are respectively supported by the two second support portions so as to be horizontally arranged, and the flip cover covers the combustion region.

By adopting the above technical solutions:

1. In the case where the fryer body and the shell are separated, food to be cooked is put into the cooking cavity through the access opening, and then the fryer body is inserted into the first chamber through the plug-in opening, and then the food in the cooking cavity is heated by burning fuel such as gas and wood under the heating region to form a flame, so that there is no need for power suppl like a conventional air fryer, and the air fryer of the present invention is more suitable for outdoor fire use, and can be directly washed with water after use, thus achieving comprehensive cleaning.

2. The flame heats the air in the combustion region and forms a heat flow. A part of the heat flow enters the second chamber from the heating region through the second flow guide opening during rising, then enters the first chamber through the third flow guide opening, and finally enters the cooking cavity through the heat flow inlet; the heat flow entering the cooking cavity flows through the food in the cooking cavity to heat the food; the other part of the heat flow enters the first air region from the heating region through the first flow guide opening during rising, then enters the space between the partition plate and left and right side walls of the fryer body through the flow guide groove, and finally enters the cooking cavity through the heat flow inlet; and the heat flow entering the cooking cavity flows through the food in the cooking cavity to heat the food.

3. It should be noted that a part of the heat flow enters the first air region from the heating region through the first flow guide opening during rising, the heat flow in the first air region contacts a lower surface of the fryer body to heat the air in a bottom portion of the cooking cavity by heat conduction to form a heat flow, and the heat flow in the bottom portion of the cooking cavity rises to flow through the food in the cooking cavity to heat the food.

4. By adopting the above heat flow heating method, since the heat flow flows only under the pressure difference generated by the combustion of the flame below, a flow rate thereof is slower than that of the conventional air fryer which is rapidly guided by the fan, which reduces the amount of moisture carried away by the heat flow during the cooking process, thus the resulting cooked food is more moist and has a better taste.

5. The heat flow from the heating region enters the second chamber to maintain the second chamber at a relatively high temperature, and airflow mixing between the second chamber and the first chamber is reduced by the partition plates, so that the second chamber and the first chamber have a significant temperature difference, so that the second chamber with a higher temperature separates the first chamber from the outside with a lower temperature, which slows down a cooling rate around the first chamber, makes the temperature in the first chamber more uniform, and has a heat preservation effect to optimize the cooking effect.

### BRIEF DESCRIPTION OF THE DRAWINGS

FIG. 1 is an assembly view of Embodiment 1 of the present invention;

FIG. 2 is an exploded view of Embodiment 1 of the present invention;

FIG. 3 is a cross-sectional view of Embodiment 1 of the present invention;

FIG. 4 is a cross-sectional view of Embodiment 1 of the present invention;

FIG. 5 is a flow schematic diagram of a heat flow in Embodiment 1 of the present invention;

FIG. 6 is a flow schematic diagram of a heat flow in Embodiment 1 of the present invention;

FIG. 7 is a flow schematic diagram of a heat flow in Embodiment 1 of the present invention;

FIG. 8 is a schematic diagram of a separated state of a housing and a fryer body in Embodiment 1 of the present invention;

FIG. 9 is a schematic diagram of a combined state of a housing and a cooktop in Embodiment 3 of the present invention;

FIG. 10 is a schematic diagram of a separated state of the housing and the cooktop in Embodiment 3 of the present invention;

FIG. 11 is a schematic diagram of an open state of the cooktop in Embodiment 3 of the present invention.

### DESCRIPTION OF REFERENCE NUMERALS

1. housing;
11. first chamber; 12. second chamber; 13 partition plate; 14. bottom plate; 15. heat-collecting hood;
111. plug-in openings; 112. first convex portion; 113. first air region; 131. third flow guide opening; 132. fourth flow guide opening; 133. first guide portion; 134. second guide portion; 141. first plate body; 142. second plate body; 143. first flow guide opening; 144. second flow guide opening; 151. heating region; 152, air intake opening;
1121. flow guide groove;
2. fryer body;
21. panel; 22. vessel; 23 handle; 24. shelf;
221. cooking cavity; 222. access opening; 223. heat flow inlet; 224. first support portion; 225. sunken portion; 226. second air region; 227. flanging; 241 rising opening;
31. first heat dissipation opening; 32. second heat dissipation opening;
41. eye ring; 42. thermometer; 43. sight glass;
5. gas burner;
51. burner; 52. knob; 53, positioning peripheral edge; 54. support ring portion; 55, cooktop;
531. combustion region; 541. second support portion; and
6. flip cover.

### DESCRIPTION OF THE EMBODIMENTS

### Embodiment 1

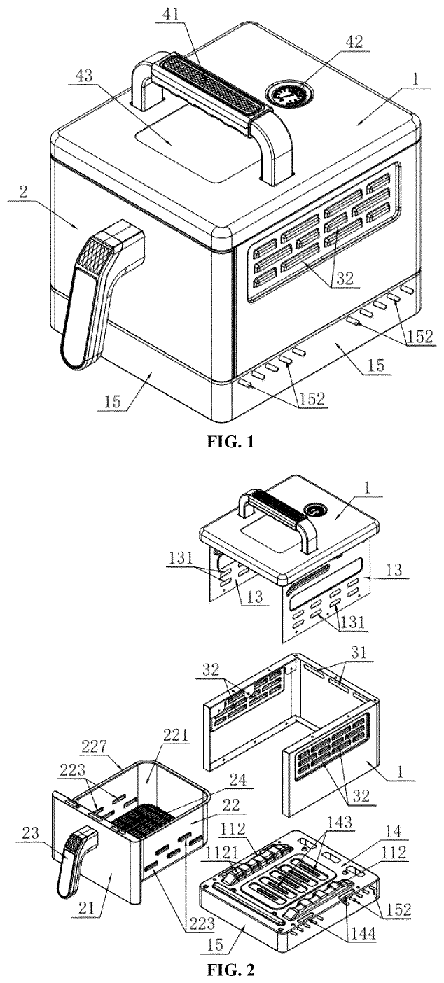

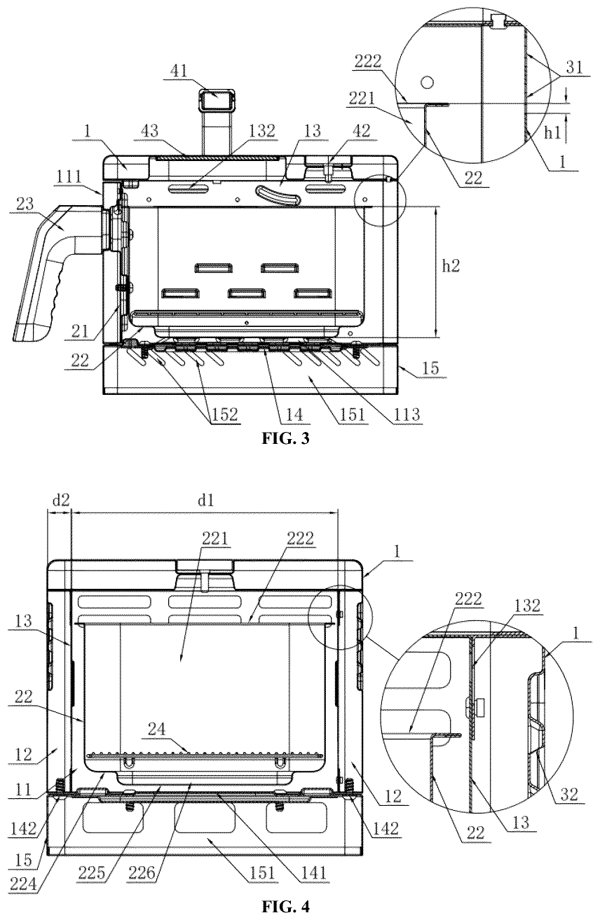

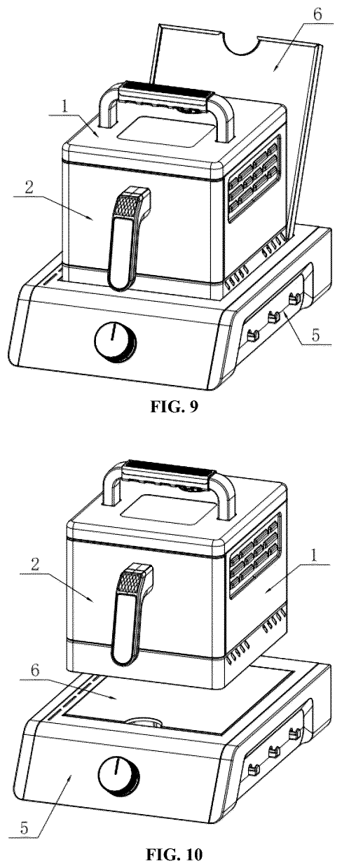

As shown in FIGS. 1-8, the present invention discloses an air fryer, including an housing 1 and a fryer body 2; a first chamber 11, a second chamber 12 located on left and right sides of the first chamber 11, and partition plates 13 separating the first chamber 11 and the second chamber 12 are provided in the housing 1, where a plug-in opening 111 is provided on a front side of the first chamber 11, and a third flow guide opening 131 is provided on the partition plate 13 to communicate the first chamber 11 with the second chamber 12; the fryer body 2 can be inserted backward into the plug-in opening 111 to enter the first chamber 11, or removed forward from the first chamber 11, where a cooking cavity 221 is provided in the fryer body 2, and the cooking cavity 221 is enclosed by a side wall and a bottom wall to form an access opening 222 above; and heat flow inlets 223 are provided on left and right side walls of the fryer body 2.

Furthermore, the housing 1 is provided with a bottom plate 14 located below the first chamber 11 and the second chamber 12, and the housing 1 is provided with a heating region 151 located below the bottom plate 14. Specifically, the bottom plate 14 includes a first plate body 141 located below the first chamber 11 and a second plate body 142 located below the second chamber 12, where a first flow guide opening 143 is provided on the first plate body 141, and a second flow guide opening 144 is provided on the second plate body 142, so that the heating region 151 is communicated with the first chamber 11 under the action of the first flow guide opening 143, and the heating region 151 is communicated with the second chamber 12 under the action of the second flow guide opening 144.

In addition, first convex portions 112 are provided in the first chamber 11, and the first convex portion 112 support the fryer body 2 so that a first air region 113 is formed between a bottom portion of the fryer body 2 and the bottom plate 14. Specifically, the number of the first convex portions 112 is two, and the two first convex portions 112 are respectively arranged on left and right sides of the first plate body 141 to correspond to the two partition plates 13, where the first convex portions 112 are in the shape of a long strip extending forward and backward, and a plurality of flow guide grooves 1121 recessed downward are arranged on an upper surface of the first convex portions 112 in a front-rear direction, so that when the fryer body 2 is placed on the first convex portions 112, the space between the partition plates 13 and the left and right side walls of the fryer body 2 is communicated with the first air region 113 through the flow guide grooves 1121.

In the present embodiment, in the case where the fryer body 2 and the housing 1 are separated, food to be cooked is put into the cooking cavity 221 through the access opening 222, and then the fryer body 2 is inserted into the first chamber 11 through the plug-in opening 111, and then the food in the cooking cavity 221 is heated by burning fuel such as gas and wood under the heating region 151 to form a flame, so that there is no need for power supply like a conventional air fryer, and the air fryer is more suitable for outdoor fire use, and can be directly washed with water after use, thus achieving comprehensive cleaning.

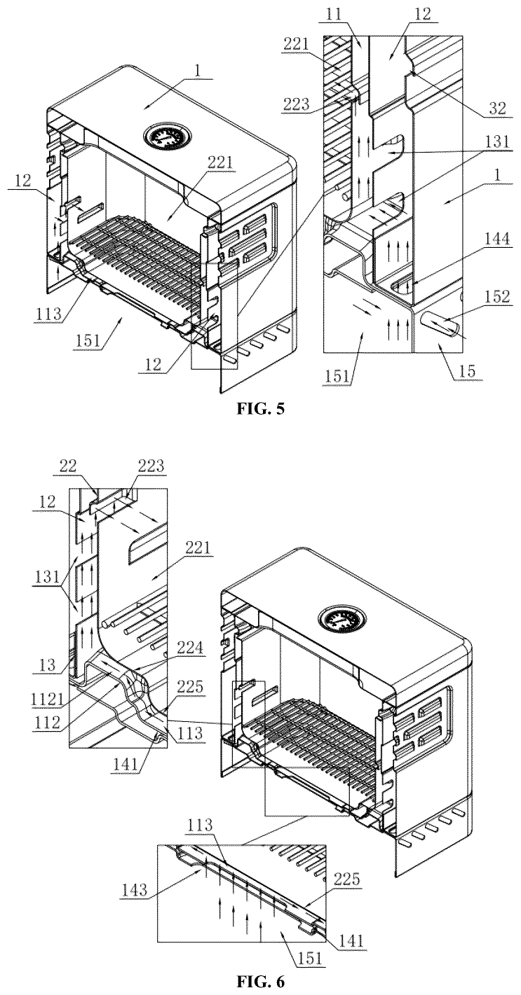

The flame heats the air in the combustion region 531 and forms a heat flow. As shown in FIG. 5, a part of the heat flow enters the second chamber 12 from the heating region 151 through the second flow guide opening 144 during rising, then enters the first chamber 11 through the third flow guide opening 131, and finally enters the cooking cavity 221 through the heat flow inlets 223, and the heat flow entering the cooking cavity 221 flows through the food in the cooking cavity 221. As shown in FIG. 6, the other part of the heat flow enters the first air region 113 from the heating region 151 through the first flow guide opening 143 during rising, then enters the space between the partition plates 13 and the left and right side walls of the fryer body 2 through the flow guide grooves 1121, and finally enters the cooking cavity 221 through the heat flow inlets 223, and the heat flow entering the cooking cavity 221 flows through the food in the cooking cavity 221.

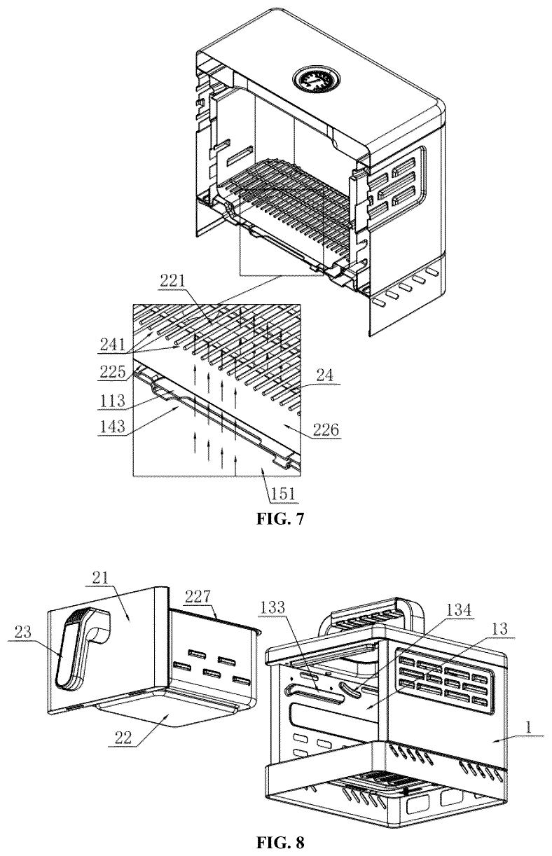

It should be noted that in addition to the two heat flows shown in FIGS. 5 and 6, there is also a heat flow as shown in FIG. 7, and the heat flow enters the first air region 113 from the heating region 151 through the first flow guide opening 143 during rising, and the heat flow in the first air region 113 contacts a lower surface of the fryer body 2 to heat the air in a bottom portion of the cooking cavity 221 by heat conduction to form a heat flow, and the heat flow in the bottom portion of the cooking cavity rises to flow through the food in the cooking cavity 221.

By adopting the above heat flow heating method, since the heat flow flows only under the pressure difference generated by the combustion of the flame below, a flow rate thereof is slower than that of the conventional air fryer which is rapidly guided by the fan, which reduces the amount of moisture carried away by the heat flow during the cooking process, thus the resulting cooked food is more moist and has a better taste.

The heat flow from the heating region 151 enters the second chamber 12 to maintain the second chamber 12 at a relatively high temperature, and airflow mixing between the second chamber 12 and the first chamber 11 is reduced by the partition plates 13, so that the second chamber 12 and the first chamber 11 have a significant temperature difference, so that the second chamber 12 with a higher temperature separates the first chamber 11 from the outside with a lower temperature, which slows down a cooling rate around the first chamber 11, makes the temperature in the first chamber 11 more uniform, and has a heat preservation effect to optimize the cooking effect.

It should be noted that the main structure of this product is formed by splicing multiple sheet metal members, which results in convenient production and assembly and safe use.

Here, a width of the first chamber 11 is d1, and a width of the second chamber 12 is d2, preferably d2≥10*d1, so that the first chamber 11 serves as a main space inside the housing 1 to provide enough space for the fryer body 2 to enter in order to cook more food.

Specifically, the third flow guide openings 131 are arranged in a plurality of rows, such as a matrix arrangement, etc. In the present embodiment, there are eight first flow guide openings 143 on each partition plate 13 which are arranged in a 2×4 matrix, and almost cover a middle lower position of a height of the fryer body 2. Correspondingly, the heat flow inlets 223 are also arranged in a plurality of rows; in the present embodiment, there are five heat flow inlets 223 on the side wall of the fryer body 2, and specifically, the heat flow inlets 223 are divided into two rows, with 2 heat flow inlets in the first row arranged at intervals and 3 heat flow inlets in the second row arranged at intervals, and the heat flow inlets almost cover to the middle lower position of the height of the fryer body 2. In contrast, an overall layout height of the third flow guide openings 131 is lower than an overall layout height of the heat flow inlets 223, so that the heat flow enters more smoothly and efficiently during rising.

It should be noted that the third flow guide openings 131 and the heat flow inlets 223 are both arranged at the lower middle position of the height of the fryer body 2, so that the heat flow entering the cooking cavity 221 flows upward from the lower middle position of the height of the cooking cavity 221 to effectively flow through the food, thus uniformly heating the food.

Preferably, the bottom portion of the fryer body 2 in the present embodiment is provided with a first support portion 224 in a square ring shape and a sunken portion 225 located on an inner periphery of the first support portion 224, where a left side portion and a right side portion of the first support portion 224 are placed on the two first convex portions 112 to be supported, and the sunken portion 225 is located between the two first convex portions 112 to be positioned left and right.

In addition, a shelf 24 arranged on the first support portion 224 is provided in the cooking cavity 221, the shelf 24 and the sunken portion 225 enclose a second air region 226, and a rising opening 241 is provided on the shelf 24 to allow air in the second air region 226 to flow upward.

Therefore, the food to be cooked is not in direct contact with the bottom portion of the cooking cavity 221 by being placed on the shelf 24, and when heated, the bottom portion of the fryer body 2 is heated by contact with the heat flow from the first air region 113, then transfers the heat energy to the air in the second air region 226 to form a heat flow, and the heat flow rises through the rising opening 241 and enters the cooking cavity 221 to heat the food by flowing therethrough, thus achieving uniform heating.

Here, the shelf 24 may be a net rack or a metal sheet rack in which the rising opening 241 is formed by blanking.

To sum up, the heat energy generated by the concentrated fire supply below is greatly dispersed, so that the heat energy is converted into heat flow to cook the food uniformly.

In addition, the housing 1 is provided with a first heat dissipation opening 31 for communicating the first chamber 11 with the outside, where a lowest position of the first heat dissipation opening 31 is lower than the access opening 222, and a height difference between the lowest position of the first heat dissipation opening 31 and the access opening 222 is h1, a height of the fryer body 2 is h2, and h2≥30*h1. Therefore, by providing the first heat dissipation opening 31 on the housing 1 which is height adapted to the access opening 222, the heat flow rising from the access opening 222 flows out through the first heat dissipation opening 31, which ensure the air flow.

In other embodiments, the lowest position of the first heat dissipation opening 31 may be arranged higher than the access opening 222, so that the heat flow rising from the access opening 222 flows out through the first heat dissipation opening 31 to ensure the air flow.

Specifically, the first heat dissipation openings 31 are arranged in a plurality of rows, such as a matrix arrangement. In the present embodiment, there are six first heat dissipation openings 31 which are arranged in a 2×3 matrix.

In addition, the housing 1 is provided with a second heat dissipation opening 32 for communicating the second chamber 12 with the outside, where a height of the second heat dissipation opening 32 approaches an upper position of the left and right side walls of the housing 1.

Therefore, under the action of the second heat dissipation opening 32, the heat flow continuously flowing into the second chamber 12 from the heating region 151 will partially continuously flow upward and flow out of the second heat dissipation opening 32, so that the second chamber 12 can be fully maintained at a high temperature for more effective heat preservation.

Furthermore, the partition plate 13 is provided with a fourth flow guide opening 132 for communicating the first chamber 11 with the second chamber 12, and a lowest position of the fourth flow guide opening 132 is higher than the access opening 222 and the second heat dissipation opening 32.

Therefore, the heat flow in the second chamber 12 also enters the first chamber 11 through the fourth flow guide opening 132, and the incoming heat flow is located above the access opening 222 to result a high temperature above the access opening 222, thus achieving a more uniform temperature in the first chamber 11 to optimize the cooking effect. In addition, since a height of the fourth flow guide opening 132 is higher than that of the second heat dissipation opening 32, the heat flow in the second chamber 12 naturally rises to the top and can only enter the first chamber 11 through the fourth flow guide opening 132, thus it is less likely that the heat flow in the first chamber 11 flows back into the second chamber 12 through the fourth flow guide opening 132 and then is discharged from the second heat dissipation opening 32, further achieving convergence of the heat flow in the first chamber 11 and resulting in a higher temperature in the first chamber 11 to realize more uniform heating.

Specifically, the second heat dissipation openings 32 are arranged in a plurality of rows, and the number of the second heat dissipation openings 32 on either left or right side of the housing 1 in the present embodiment is 12. Specifically, the second heat dissipation openings 32 are divided into three rows, with each row having four second heat dissipation openings.

Here, the fryer body 2 includes a panel 21, a vessel 22 and a handle 23, the panel 21 is square to adapt to the shape and size of the plug-in opening 111, and the vessel 22 is a rectangular parallelepiped with an empty interior, a front side of the vessel 22 and a rear side of the panel 21 are fixedly mounted by bolts, and the handle 23 is fixed to a front side of the panel 21.

Therefore, the user inserts the vessel 22 into the first chamber 11 by holding the handle 23, and completes positioning when the panel 21 and the housing 1 abut against each other at the plug-in opening 111, and closes the plug-in opening 111 to allow the heat flow in the first chamber 11 to better act on the food in the cooking cavity 221.

Preferably, a bottom portion of the housing 1 in the present embodiment is provided with a heat-collecting hood 15 surrounding an outer periphery of the heating region 151, the heat collecting hood 15 is provided with an air intake opening 152 communicating the heating region 151 with the outside, so that outgoing heat flow from the heating region 151 is reduced by the heat collecting hood 15. In addition, the air intake opening 152 is provided to supply air as the heat flow rises from the first flow guide opening 143 and the second guide opening 144 to form a continuous airflow and to supply oxygen to achieve sufficient flame combustion.

In addition, a top portion of the housing 1 in the present embodiment is also provided with a U-shaped eye ring 41, so that the housing 1 or the housing 1 together with the fryer body 2 can be separated from the flame by the eye ring 41, and has a portable effect.

Moreover, the top portion of the housing 1 in the present embodiment is further provided with a thermometer 42, a display portion of the thermometer 42 is provided at the top portion of the housing 1 for data reading, and a detection end of the thermometer 42 extends into the first chamber 11 to detect the temperature inside the first chamber 11 in real time.

In addition, the top portion of the housing 1 in the present embodiment is also provided with a sight glass 43, and the sight glass 43 is closed by a transparent glass plate, so that a cooking state of the food in the cooking cavity 221 can be observed through the sight glass 43 to better judge the food state to adjust subsequent cooking means.

Furthermore, the two partition plates 13 in the present embodiment are provided with a first guide portion 133 and a second guide portion 134 protruding toward each other, the first guide portion 133 is close to the plug-in opening 111, and is inclined backward and upward by a distance, and then extends horizontally backward, the second guide portion 134 is located on an upper side of a rear portion of the first guide portion 133, and the second guide portion 134 is inclined backward and downward, and correspondingly, a flanging 227 extending outward is provided on an outer periphery of an upper side of the vessel 22, and is clamped between the first guide portion 133 and the second guide portion 134 by the flanging 227 for vertical limiting.

### Embodiment 2

The invention discloses an air fryer which has a main structure the same as that of Embodiment 1, except that the first flow guide opening 143 is not provided, and the first plate body 141 is a closed plate body to separate the heating region 151 from the first chamber 11, where the first plate body 141 is made of a metal plate with a good heat conduction capability, so that the flame in the heating region 151 burns the first plate body 141, and then the air in the first air region 113 is heated by diffusing heat energy through the upper surface of the first plate body 141 for heat transfer.

The present embodiment has the advantage that, regardless of the condition of the underlying flame, the flame does not cross the first plate body 141 and burn directly on the fryer body 2, but the first plate body 141 is burned to cause the upper surface of the heated first plate body 141 to heat the first air region 113 in a surface diffusion manner, and then the lower surface of the fryer body 2 is heated by the first air region 113, thus improving heating uniformity.

### Embodiment 3

As shown in FIGS. 9 to 11, the present invention discloses an air fryer which has a main structure the same as that of Embodiment 1 or Embodiment 2, except that the air fryer further includes a gas burner 5, and the housing 1 is placed on the gas burner 5 to allow the gas burner 5 to burn and produce a flame in a heating region 151.

Therefore, the cooking uniformity is further improved by using the gas burner 5 to burn and provide a stable fire source, and the use of the gas burner 5 outdoors is safer and more convenient than the combustion of wood and charcoal outdoors, and the fire can be ignited and turned off in time.

Specifically, the gas burner 5 includes a cooktop 55 and a burner 51, a knob 52, a piping assembly (not shown for perspective reasons) and the like provided on the cooktop 55, the burner 51 is provided above the cooktop 55, the knob 52 is provided on a front side of the cooktop 55, and the piping assembly connects the knob 52 and the burner 51, so that the piping assembly connects a gas tank for gas delivery to control ignition of the burner 51.

In addition, a positioning peripheral edge 53 surrounding an outer periphery of the burner 51 is provided above the cooktop 55 by means of sheet metal so that a combustion region 531 is formed in the positioning peripheral edge 53, the housing 1 is placed in the combustion region 531, and an outer peripheral wall of the housing 1 is surrounded and positioned by the positioning peripheral edge 53 to achieve a more stable housing 1 and safe cooking effect.

Moreover, a square-shaped support ring portion 54 protruding upward is provided on a bottom portion of the combustion region 531 by means of sheet metal, and the support ring portion 54 includes second support portions 541 on left and right sides, and when the housing 1 is placed on the cooktop 55, left and right bottom portions of the housing 1 are supported by the second support portions 541. Here, a spacing between the burner 51 and the bottom plate 14 can be controlled by controlling a height of the support ring portion 54 to control the flame in the heating region 151, for example, to prevent the flame from burning the bottom portion of the fryer body 2 by directly entering the first air region 113 through the first flow guide opening 143, resulting in uneven heating, etc.

In addition, a flip cover 6 is provided in the combustion region 531 in a flipping manner, and a hinge position of the flip cover 6 is located on a rear side of the combustion region 531 and above the second support portions 541.

The flip cover 6 has an open state and a closed state.

When in the open state, as shown in FIG. 9, the flip cover 6 is inclined backward and upward, and is supported against a rear side of an inner periphery of the positioning peripheral edge 53, in this case, the housing 1 can be placed in the combustion region 531 for use, and a center of gravity of the flip cover 6 drives the flip cover 6 to continue to flip downward, that is, away from the housing 1 so as not to interfere with the housing 1, ensuring the stability of the housing 1.

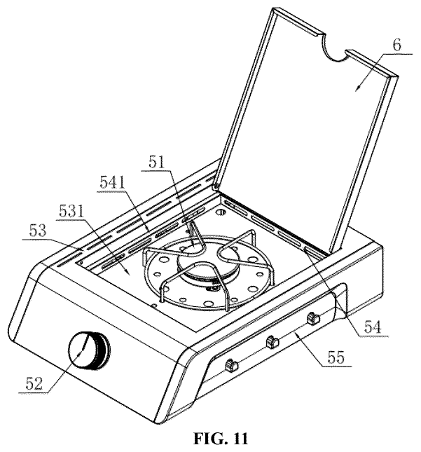

When in the closed state, as shown in FIG. 10, left and right sides of the flip cover 6 are respectively supported by the two second support portions 541 to be arranged horizontally, and the flip cover 6 covers the combustion region 531, in this case, the flip cover 6 closes the combustion region 531 and can protect the burner, and the flip cover 6 is horizontal, so that the unused housing 1 can be placed thereon for support.

What is claimed is:

1. An air fryer, comprising:
a housing, a first chamber, a second chamber located on both sides of the first chamber and partition plates separating the first chamber from the second chamber being provided in the housing, a plug-in opening being provided on one side of the first chamber, and a third flow guide opening being provided on the partition plates to communicate the first chamber with the second chamber; and
a fryer body, the fryer body being disassembled and assembled relative to the first chamber by the plug-in opening, a cooking cavity being provided in the fryer body, and a heat flow inlet being provided on a side wall of the fryer body;
the housing being provided with a bottom plate located below the first chamber and the second chamber, the housing being provided with a heating region located below the bottom plate, a second flow guide opening being provided on the bottom plate to communicate the second chamber with the heating area, the heating region being configured to provide a space for flame combustion, and a heat flow generated by the flame combustion entering the cooking cavity through the second flow guide opening, the second chamber, the third flow guide opening, the first chamber and the heat flow inlet in sequence.

2. The air fryer according to claim 1, wherein first convex portions are provided in the first chamber, and the first convex portions support the fryer body so that a first air region is formed between a bottom portion of the fryer body and the bottom plate;
the number of the first convex portions is two, and the two first convex portions are respectively arranged on both sides of the bottom plate to correspond to two partition plates; and
an upper surface of the first convex portion is concavely provided with a flow guide groove, and air flow in the first air region flows between the partition plates and the side wall of the fryer body through the flow guide groove and continues to rise through the heat flow inlet to enter the cooking cavity.

3. The air fryer according to claim 2, wherein the bottom plate comprises a first plate body located below the first chamber; and
the first plate body is a closed plate body to separate the heating region from the first chamber, and the first plate body is a heat conducting plate.

4. The air fryer according to claim 2, wherein the bottom plate comprises a first plate body located below the first chamber; and
a first flow guide opening is provided on the first plate body to communicate the heating region with the first air region, and the heat flow generated by the flame combustion in the heating region enters the first air region through the first flow guide opening.

5. The air fryer according to claim 2, wherein the bottom portion of the fryer body is provided with an annular first support portion and a sunken portion located on an inner periphery of the first support portion, the first support portion is placed on the two first convex portions to be supported, and the sunken portion is located between the two first convex portions for positioning; and
a shelf arranged on the first support portion is provided in the cooking cavity, the shelf and the sunken portion enclose a second air region, and a rising opening is provided on the shelf to allow air in the second air region to flow upward.

6. The air fryer according to claim 2, wherein an access opening is provided above the fryer body for the heat flow in the cooking cavity to flow out upward;
the housing is provided with a first heat dissipation opening for communicating the first chamber with the outside;
a lowest position of the first heat dissipation opening is higher than the access opening; or the lowest position of the first heat dissipation opening is lower than the access opening, a height difference between the lowest position of the first heat dissipation opening and the access opening is h1, a height of the fryer body is h2, and h2≥30*h1; and
the housing is provided with a second heat dissipation opening for communicating the second chamber with the outside, the partition plate is provided with a fourth flow guide opening for communicating the first chamber with the second chamber, and a lowest position of the fourth flow guide opening is higher than the access opening and the second heat dissipation opening.

7. The air fryer according to claim 1, wherein the plug-in opening is arranged on a front side of the first chamber, and the second chamber is arranged on left and right sides of the first chamber; and
the fryer body comprises a panel, a vessel and a handle, the vessel is fixedly arranged on a rear side of the panel, the handle is fixedly arranged on a front side of the panel, the vessel is inserted into the first chamber through the plug-in opening, and the plug-in opening is closed by the panel.

8. The air fryer according to claim 1, wherein the housing is provided with a heat-collecting hood surrounding an outer periphery of the heating region, and the heat-collecting hood is provided with an air intake opening communicating the heating region with the outside.

9. The air fryer according to claim 1, further comprising a gas burner, wherein the housing is placed on the gas burner to allow the gas burner to burn and produce a flame in the heating region.

10. The air fryer according to claim 9, wherein the gas burner comprises a cooktop and a burner provided on the cooktop, the cooktop is provided with a positioning peripheral edge surrounding an outer periphery of the burner such that a combustion region is formed in the positioning peripheral edge, the housing is placed in the combustion region, and an outer peripheral wall of the housing is surrounded and positioned by the positioning peripheral edge.

11. The air fryer according to claim 10, wherein second support portions protruding upward are provided on left and right sides of a bottom portion of the combustion region, and a bottom portion of the housing is supported on the second support portions;
a flip cover is provided in the combustion region in a flipping manner, and a hinge position of the flip cover is located on a rear side of the combustion region and above the second support portions;
the flip cover has an open state and a closed state;
when in the open state, the flip cover is inclined backward and upward, and is supported against a rear side of an inner periphery of the positioning peripheral edge; and
when in the closed state, left and right sides of the flip cover are respectively supported by the two second support portions so as to be horizontally arranged, and the flip cover covers the combustion region.
